(19) United States
(12) Patent Application Publication
(10) Pub. No.: US 2014/0022762 A1
(43) Pub. Date: Jan. 23, 2014

(54) BACKLIGHT MODULE

(71) Applicant: TPV DISPLAY TECHNOLOGY (XIAMEN) CO., LTD., Xiamen (CN)

(72) Inventors: Jun-Yi ZHENG, Xiamen (CN); Wei LIN, Xiamen (CN); Po-Iem LIN, Hsinchu City (TW)

(73) Assignee: TPV DISPLAY TECHNOLOGY (XIAMEN) CO., LTD., Xiamen (CN)

(21) Appl. No.: 13/846,029

(22) Filed: Mar. 18, 2013

(30) Foreign Application Priority Data
Jul. 23, 2012 (CN) 201210257025.0
Oct. 31, 2012 (TW) 101140354
Oct. 31, 2012 (TW) 101221056

(51) Int. Cl. F21K 99/00

(52) U.S. Cl. CPC F21K 9/50
USPC 362/97.1

(57) ABSTRACT

A backlight module includes: a light diffusion unit including a diffusing plate and a plurality of light diffusion elements formed on the diffusing plate, each of the light diffusion elements having a first diffusion pattern which has a first light-permeable region and a first light-blocking region, and a second diffusion pattern which surrounds the first diffusion pattern and which has a continuous second light-permeable region and a plurality of second light-blocking regions distributed in the continuous light-permeable region; and a light source disposed adjacent to the light diffusion unit and emitting light beams to the light diffusion unit.

### CROSS-REFERENCE TO RELATED APPLICATION

This application claims priority of Chinese Patent application no. 201210257025.0, filed on Jul. 23, 2012.

### BACKGROUND OF THE INVENTION

1. Field of the Invention

This invention relates to a backlight module, more particularly to a backlight module that has a micro-structure design.

2. Description of the Related Art

A conventional flat panel display generally adopts TFT-LCD as a liquid crystal module. Since TFT-LCD is a passive display, the conventional flat panel display is usually equipped with a backlight module which provides light and a color filter which receives the light from the backlight module to achieve a full-color display.

The conventional flat panel display includes a diffuser and a light source. Since a light emitting diode (LED) has a small volume and low energy consumption, the same is gradually used as a light source in the flat panel display. A plurality of light emitting diodes are generally applied in a backlight module of the flat panel display and are arranged on the diffuser in a dot matrix arrangement. In this arrangement, the backlight module usually has a problem non-uniform lighting. For eliminating the aforesaid drawback, microstructure units are formed on a light emitting surface or a light incident surface of the diffuser, or an optical film optionally formed with a plurality of microstructures is configured on the light emitting surface of the diffuser.

However, the microstructures of the conventional backlight module are usually arranged in a single pattern. The single pattern of the microstructures restricts light diffusion efficiency, thereby resulting in limited light uniformity of light beams from the light emitting diodes.

### SUMMARY OF THE INVENTION

Therefore, an object of the present invention is to provide a backlight module for a display device that can overcome the aforesaid drawbacks associated with the prior art.

Accordingly, a backlight module of this invention includes:

a light diffusion unit including a diffusing plate and a plurality of light diffusion elements formed on the diffusing plate, each of the light diffusion elements having a first diffusion pattern which has a first light-permeable region and a first light-blocking region, and a second diffusion pattern which surrounds the first diffusion pattern and which has a continuous second light-permeable region and a plurality of second light-blocking regions distributed in the continuous light-permeable region; and

a light source disposed adjacent to the light diffusion unit and emitting light beams to the light diffusion unit.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a liquid crystal display device which includes the preferred embodiment of a backlight module according to this invention;

FIG. 2 is a perspective view of a light diffusion plate of the preferred embodiment of the backlight module according to this invention, which shows a first configuration of first and second diffusion patterns included in the light diffusion plate of the preferred embodiment;

FIG. 3 is a schematic view showing a second configuration of the first and second diffusion patterns of the light diffusion plate of the preferred embodiment;

FIG. 4 is a schematic view showing a third configuration of the first and second diffusion patterns of the light diffusion plate of the preferred embodiment;

FIG. 5 is a schematic view showing a fourth configuration of the first and second diffusion patterns of the light diffusion plate of the preferred embodiment; and

FIG. 6 is a schematic view showing a fifth configuration of the first diffusion pattern of the light diffusion plate of the preferred embodiment.

### DETAILED DESCRIPTION OF THE PREFERRED EMBODIMENT

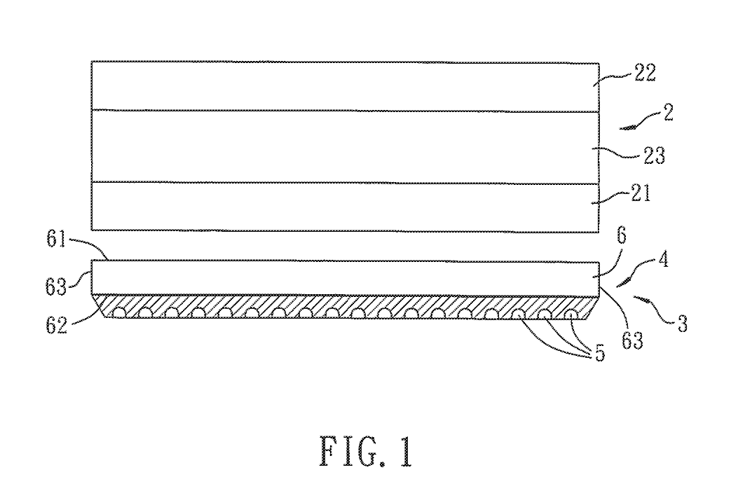

FIG. 1 shows a liquid crystal display device which includes a display unit 2 and the preferred embodiment of a backlight module 3 according to this invention.

The display unit 2 includes a thin film transistor substrate 21, a color filter substrate 22, and a liquid crystal layer 23 disposed between the thin film transistor substrate 21 and the color filter substrate 22. It is noted that, if desired, the display unit 2 may further include other optical elements, such as polarizing plates (not shown). Since the display unit 2 and the optical elements included therein are well known to a skilled artisan, detailed descriptions thereof are omitted herein for the sake of brevity.

The preferred embodiment of the backlight module 3 of this invention is disposed on one side of the thin film transistor substrate 21 opposite to the liquid crystal layer 23, and includes a light diffusion unit 4 and a light source 5.

The light diffusion unit 4 includes a diffusing plate 6 and a plurality of light diffusion elements 7 formed on the diffusing plate 6.

The diffusing plate 6 has a light incident surface 62 through which light beams from the light source 5 enter into the diffusing plate 6, a light emitting surface 61 that is disposed adjacent to the display unit 2 and opposite to the light incident surface 62, and a peripheral surface interconnecting the light emitting surface 61 and the light incident surface 62.

The diffusing plate 6 is made of, e.g., polyethylene terephthalate (PET), propylene carbonate (PC), polymethylmethacrylate (PMMA), polystyrene (PS), or acrylate. The diffusing plate 6 preferably has a transmittance ranging from 40% to 80%, a haze value higher than 60%, and a thickness ranging from 0.5 mm to 3 mm.

The light diffusion elements 7 can be formed by etching, inkjet printing, adhesion, or screen printing.

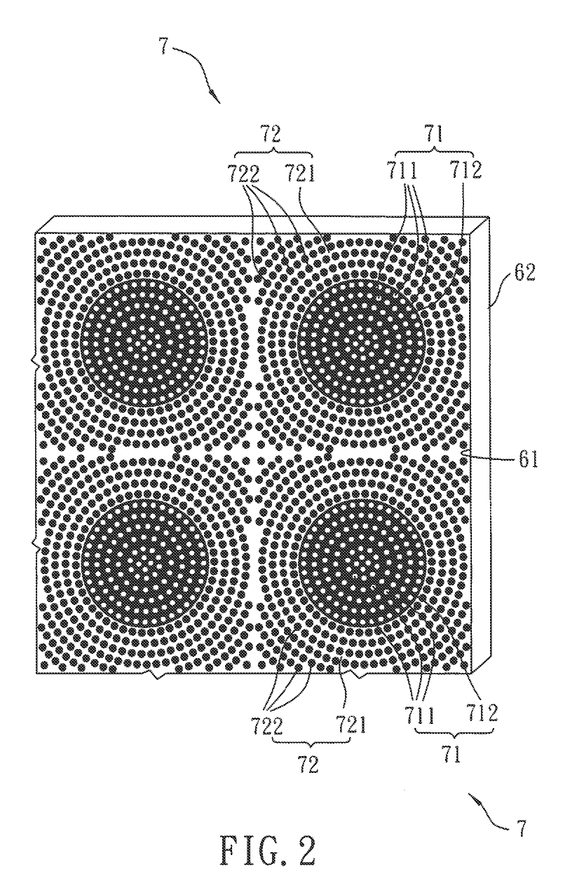

As shown in FIG. 2, each of the light diffusion elements 7 has a first diffusion pattern 71 and a second diffusion pattern 72 which surrounds the first diffusion pattern 71. The first diffusion pattern 71 has a first light-permeable region 711 and a first light-blocking region 712. In this embodiment, the first light-blocking region 712 is in continuous phase, and the first light-permeable region 711 is distributed in the continuous first light-blocking region 712. The second diffusion pattern 72 has a continuous second light-permeable region 721 and a plurality of second light-blocking regions 722 distributed in the continuous light-permeable region 721.

The light source 5 is disposed adjacent to the light diffusion unit 4 so as to emit light beams to the light diffusion unit 4. By virtue of the structural design of the first and second diffusion patterns 71, 72, the light beams from the light source 5 could be uniformly emitted by the backlight module 3.

As shown in FIG. 2, which shows the first configuration of the first and second diffusion patterns 71, 72, the first light-permeable region 711 is composed of a plurality of spaced apart light-permeable areas distributed in the first light-blocking region 712. In the first configuration, the spaced apart light-permeable areas of the first light-permeable region 711 are arranged in a plurality of spaced apart first concentric rings each of which has a density of the light-permeable areas identical to that of an adjacent one of the first concentric rings. That is, in each of the first concentric rings, the light-permeable areas are equidistantly disposed. The second light-blocking regions 722 are arranged in a plurality of second concentric rings. Each of the second concentric rings has a density of the second light-blocking regions identical to that of an adjacent one of the second concentric rings. That is, in each of the second concentric rings, the second light-blocking regions 722 are equidistantly disposed.

In FIG. 2, the light-permeable areas and the second light-blocking regions 722 have a circular shape. However, the shape of the light-permeable areas and the second light-blocking regions 722 can independently be, e.g., a triangle, a tetragon, or a star.

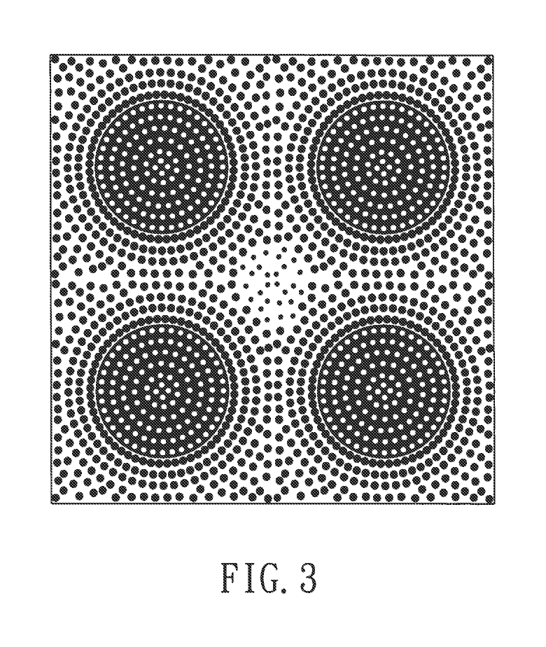

It should be noted that, each of the first concentric rings can have a density of the light-permeable areas different from that of the adjacent one of the first concentric rings. For example, the first concentric rings have densities of the light-permeable areas increasing or decreasing outwardly from a common center of the first concentric rings. Similarly, each of the second concentric rings can have a density of the second light-blocking regions 722 different from that of the adjacent one of the second concentric rings, e.g., increasing or decreasing radially outward. For example, in FIG. 3 which shows the second configuration of the first and second diffusion patterns 71, 72, the density of the second light-blocking regions 722 in the second concentric rings is decreased radially outward.

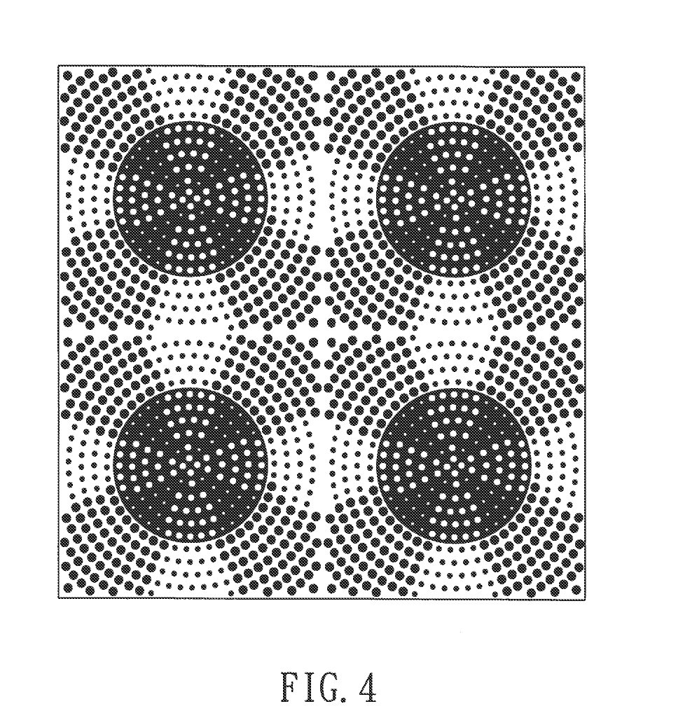

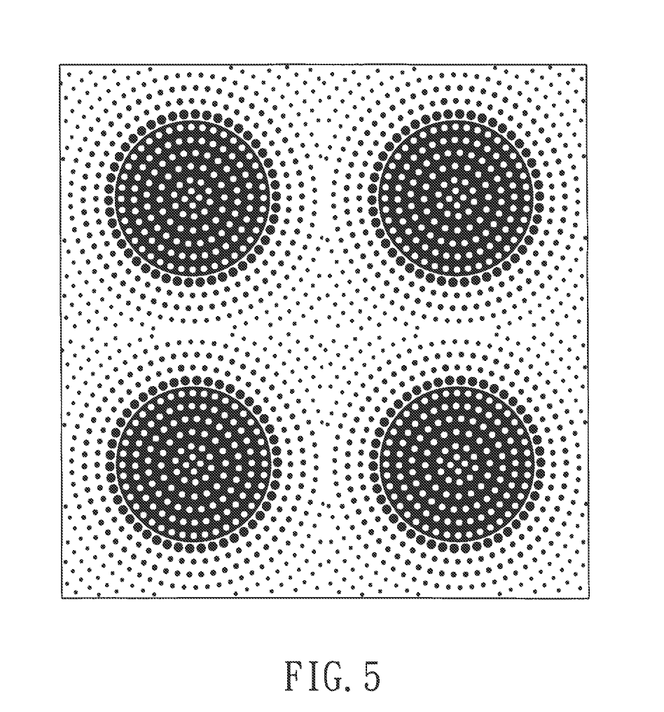

Also, the sizes of the light-permeable areas and the second light-blocking regions 722 can vary, independently, to adjust density thereof. For example, in FIG. 4 which shows the third configuration of the first and second diffusion patterns 71, 72, there are two different sizes of the light-permeable areas in each of the first concentric rings. The second concentric rings have a similar design. In FIG. 5 which shows the fourth configuration of the first and second diffusion patterns 71, 72, the sizes of the second light-blocking regions 722 in the second concentric rings are decreased radially outward.

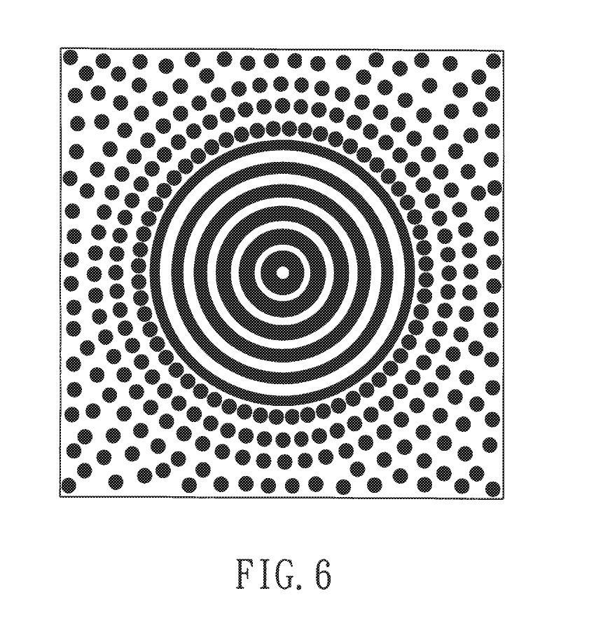

Alternatively, as shown in FIG. 6 which shows the fifth configuration of the first diffusion pattern 71, the first light-permeable region 711 is composed of a plurality of light-permeable rings concentrically arranged in the first light blocking region 712.

In this embodiment, the backlight module 3 is a direct type backlight, and thus, the light source 5 is disposed adjacent to the light incident surface 62. The light source 5 includes a plurality of light emitting diodes each of which has a lighting center corresponding in position to a center of a respective one of the light diffusion elements 7. The light diffusion elements 7 may be disposed on one or both of the light emitting and incident surfaces 61, 62. In this embodiment, the light diffusion elements 7 are formed on the light incident surface 62.

When the light diffusion elements 7 are formed on one of the light emitting and light incident surfaces 61, 62, the backlight module 3 may further include a light diffusion member (not shown), such as a prism structure that is disposed on the other one of the light emitting and light incident surfaces 61, 62. The light diffusion member is capable of optimizing diffusion effect of the light beams from the light source 5.

Moreover, the light source 5 of this invention may further include a plurality of optical components (e.g., LED lens, not shown) mounted on the light emitting diodes and facilitating emission of light beams at a wider angle. The optical components are capable of optimizing diffusion of the light beams emitted from the light emitting diodes so as to reduce a required number of the light emitting diodes of the light source 5.

To sum up, in this invention, by virtue of different arrangements of the first and second diffusion patterns 71, 72, uniformity of light from the backlight module 3 can be raised. Besides, by adjusting distributions or sizes of the light-permeable areas and the second light-blocking regions 722, uniformity of light can be further improved.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A backlight module of a display device, comprising:
a light diffusion unit including a diffusing plate and a plurality of light diffusion elements formed on said diffusing plate, each of said light diffusion elements having a first diffusion pattern which has a first light-permeable region and a first light-blocking region, and a second diffusion pattern which surrounds said first diffusion pattern and which has a continuous second light-permeable region and a plurality of second light-blocking regions distributed in said continuous light-permeable region; and
a light source disposed adjacent to said light diffusion unit and emitting light beams to said light diffusion unit.

2. The backlight module of claim 1, wherein said light source includes a plurality of light emitting diodes, each of which has a lighting center corresponding in position to a center of a respective one of said light diffusion elements.

3. The backlight module of claim 1, wherein said light source includes a plurality of light emitting diodes and a plurality of optical components which help to emit light at a wider angle.

4. The backlight module of claim 1, wherein said diffusing plate has a light incident surface and a light emitting surface, said light diffusion elements being formed on said light emitting surface and said light incident surface.

5. The backlight module of claim 1, wherein said diffusing plate has a light incident surface and a light emitting surface, the backlight module further comprising a light diffusion member, said light diffusion elements being formed on one of said light emitting surface and said light incident surface, said light diffusion member being disposed on the other one of said light emitting surface and said light incident surface.

6. The backlight module of claim 1, wherein said light diffusion elements are formed by etching, inkjet printing, adhesion, or screen printing.

7. The backlight module of claim 1, wherein said first light-permeable region is composed of a plurality of spaced apart light-permeable areas distributed in said first light-blocking region.

8. The backlight module of claim 7, wherein each of said light-permeable areas has a shape of a circle, a triangle, a tetragon, or a star.

9. The backlight module of claim 7, wherein said spaced-apart light-permeable areas are arranged in a plurality of spaced apart first concentric rings.

10. The backlight module of claim 9, wherein each of said first concentric rings has a density of said light-permeable areas identical to that of an adjacent one of claim first concentric rings.

11. The backlight module of claim 9, wherein each of said first concentric rings has a density of said light-permeable areas different from that of an adjacent one of said first concentric rings.

12. The backlight module of claim 9, wherein said first concentric rings have densities of said light-permeable areas increasing from a common center of said first concentric rings.

13. The backlight module of claim 9, wherein said first concentric rings have densities of said light-permeable areas decreasing from a common center of said first concentric range.

14. The backlight module of claim 1, wherein each of said second light-blocking regions has a shape of a circle, a triangle, a tetragon, or a star.

15. The backlight module of claim 1, wherein said second light-blocking regions are arranged in a plurality of second concentric rings.

16. The backlight module of claim 15, wherein each of said second concentric rings has a density of said second light-blocking regions identical to that of an adjacent one of said second concentric rings.

17. The backlight module of claim 15, wherein each of said second concentric rings has a density of said second light-blocking regions different from that of an adjacent one of said second concentric rings.

18. The backlight module of claim 15, wherein said second concentric rings have densities of said second light-blocking regions increasing radially outward.

19. The backlight module of claim 15, wherein said second concentric rings have densities of said second light-blocking regions decreasing radially outward.

20. The backlight module of claim 1, wherein said first light-permeable region is composed of a plurality of light-permeable rings concentrically arranged in said first light-blocking region.
